(19) United States
(12) Patent Application Publication
(10) Pub. No.: US 2026/0080305 A1
(43) Pub. Date: Mar. 19, 2026

(54) AUDITABLE DATA PROVENANCE FOR TRAINING DATASET PREDICTION IN LARGE FOUNDATIONAL MODELS

(71) Applicant: Red Hat, Inc., Raleigh, NC (US)

(72) Inventors: Leigh Griffin, Waterford (IE); Andrea Cosentino, Milan (IT)

(21) Appl. No.: 18/890,281

(22) Filed: Sep. 19, 2024

(51) Int. Cl. G06N 20/00

(52) U.S. Cl. CPC G06N 20/00

(57) ABSTRACT

A particular training example is obtained from a training data source. A machine-learned model is trained based at least in part on the particular training example. Training verification information is generated for the particular training example, wherein the training verification information comprises at least one of example sourcing information descriptive of characteristics of the training data source and/or the particular training example, or model training information descriptive of characteristics of the machine-learned model while training the machine-learned model based on the particular training example. An auditable training ledger associated with the machine-learned model is modified to append an entry for the particular training example based on the training verification information to a plurality of entries of the auditable training ledger.

### BACKGROUND

Model training refers to the process of training a machine-learned model to recognize patterns, make decisions, and/or generate outputs. Model learning is generally accomplished with a combination of training data and learning algorithm(s) (e.g., an optimization function, backpropagation, etc.). Model training can be performed by inputting large datasets to a model and optimizing the model based on the outputs received from the model (or the accuracy thereof), thus training the model through iterative optimization processes. During training, the model can be optimized by adjusting the model’s internal parameters to minimize prediction errors, effectively "learning" the underlying relationships within the data. Training can be supervised, where the model is guided by labeled examples, or unsupervised, where it identifies patterns without explicit guidance. This process is fundamental to developing artificial intelligence systems that can perform complex tasks such as image recognition, natural language processing, and predictive analytics.

### SUMMARY

Implementations described herein provide for auditable data provenance for training dataset prediction in large foundational models. For example, a computing system can obtain a training example. The computing system can train a machine-learned model using the training example. The computing system can generate training verification information for the training example. The computing system can modify an auditable training ledger to append an entry for the training example to the ledger. The ledger can then be utilized to enable data provenance for machine-learned models trained using such examples, and additionally, can be leveraged to perform various tasks, such as training dataset prediction.

In one implementation, a method is provided. The method includes obtaining, by a computing system comprising one or more computing devices, a particular training example from a training data source. The method further includes training, by the computing system, a machine-learned model based at least in part on the particular training example. The method further includes generating, by the computing system, training verification information for the particular training example, wherein the training verification information comprises at least one of example sourcing information descriptive of characteristics of the training data source and/or the particular training example; or model training information descriptive of characteristics of the machine-learned model while training the machine-learned model based on the particular training example. The method further includes modifying, by the computing system, an auditable training ledger associated with the machine-learned model to append an entry for the particular training example to a plurality of entries of the auditable training ledger, wherein the entry to the auditable training ledger is based on the training verification information.

In another implementation, a computing system is provided. The computing device includes a memory, and one or more processor devices coupled to the memory. The one or more processor devices are to obtain a particular training example from a training data source. The one or more processor devices are further to train a machine-learned model based at least in part on the particular training example. The one or more processor devices are further to generate training verification information for the particular training example, wherein the training verification information comprises at least one of example sourcing information descriptive of characteristics of the training data source and/or the particular training example; or model training information descriptive of characteristics of the machine-learned model while training the machine-learned model based on the particular training example. The one or more processor devices are further to modify an auditable training ledger associated with the machine-learned model to append an entry for the particular training example to a plurality of entries of the auditable training ledger, wherein the entry to the auditable training ledger is based on the training verification information.

In another implementation, a non-transitory computer-readable storage medium is provided. The non-transitory computer-readable storage medium includes executable instructions to cause one or more processor devices to obtain a particular training example from a training data source. The instructions further cause the one or more processor devices to train a machine-learned model based at least in part on the particular training example. The instructions further cause the one or more processor devices to generate training verification information for the particular training example, wherein the training verification information comprises at least one of example sourcing information descriptive of characteristics of the training data source and/or the particular training example; or model training information descriptive of characteristics of the machine-learned model while training the machine-learned model based on the particular training example. The instructions further cause the one or more processor devices to modify an auditable training ledger associated with the machine-learned model to append an entry for the particular training example to a plurality of entries of the auditable training ledger, wherein the entry to the auditable training ledger is based on the training verification information.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing environment suitable for auditable data provenance for training dataset prediction in large foundational models according to some implementations of the present disclosure.

FIG. 2 illustrates an example of the auditable training ledger of FIG. 1 including the new ledger entry that includes the training verification information according to some implementations of the present disclosure.

FIG. 3 is a flowchart illustrating operations performed by the computing system of FIG. 1 for auditable data provenance for training dataset prediction in large foundational models, according to one example.

FIG. 4 is a block diagram of the computing device of FIG. 1 for auditable data provenance for training dataset prediction in large foundational models, according to one example.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Training refers to the process of training a machine-learned model to recognize patterns, make decisions, and/or generate outputs. Model learning is generally accomplished with a combination of training data and learning algorithm(s) (e.g., an optimization function, backpropagation, etc.). Model training can be performed by inputting large datasets to a model and optimizing the model based on the outputs received from the model (or the accuracy thereof), thus training the model through iterative optimization processes. During training, the model can be optimized by adjusting the model’s internal parameters to minimize prediction errors, effectively "learning" the underlying relationships within the data. Training can be supervised, where the model is guided by labeled examples, or unsupervised, where it identifies patterns without explicit guidance. This process is fundamental to developing artificial intelligence systems that can perform complex tasks such as image recognition, natural language processing, and predictive analytics.

Recent advancements in the field of machine learning have demonstrated that model performance can scale favorably with the size of the training dataset used to train the model and/or the size of the model itself. In other words, model performance can be improved substantially by increasing the number of parameters that comprise a machine-learned model, and/or increasing the number of training examples used to train the machine-learned model. Models with large numbers of parameters that are trained on substantially larger corpuses of training data are generally referred to as “Large Foundational Models,” or LFMs. LFMs generally exhibit superior performance to smaller models of the same type. In addition, many LFMs can perform multiple types of tasks. For example, a Large Language Model (LLM) can perform a wide variety of generative language tasks (e.g., summarizing existing textual content, generating new textual content, searching for a particular word, etc.).

LFMs, and machine-learned models generally, are trained using training examples. As described herein, a “training example” generally refers to input(s) that are processed with the purpose of optimizing a machine-learned model. Training examples may (or may not) include ground-truth information (e.g., labels, outputs, etc.) indicating a “correct” output that the model can be trained to reproduce when given the corresponding input of the training example.

The observed increases in model performance demonstrated by LFMs has created a race to train increasingly large models with increasingly larger quantities of training data. However, the training examples that comprise training data (and supervised training examples in particular) are a limited resource, as they cannot be “reused” to train the same model. Furthermore, whether creating new training examples or obtaining new training examples from a third party, new training examples can be substantially expensive to acquire. As such, training data has become an increasingly valuable and scarce resource in the field of Artificial Intelligence (AI).

Due to these constraints, many entities leverage public datasets when training machine-learned models, as public training datasets are generally free to use. However, public training datasets usually lack metadata or contextual information for specific training examples included in the public training dataset. As such, a training example obtained from a public training dataset generally cannot be audited to identify the source of the training example, the time at which the training example was created, privacy concerns associated with the training example, malicious threats associated with the training example, etc. Thus, an approach to accurately and efficiently enable auditable data provenance for training machine-learned models is greatly desired.

Accordingly, implementations of the present disclosure propose auditable data provenance for training dataset prediction in large foundational models. Specifically, a computing system (e.g., a system associated with an entity training a machine-learned model) can obtain a particular training example from a training data source (e.g., a third-party training data provider, a device (e.g., a user device), an existing dataset, etc.). The computing system can train a machine-learned model based on the training example. For example, if the training example is a supervised training example that includes a ground-truth output, the computing system can process the training example with the model to obtain a training output, and can adjust parameters of the model based on difference(s) between the training output and the ground-truth output.

The computing system can generate training verification information for the particular training example. In some implementations, the training verification information can include example sourcing information. The example sourcing information can describe characteristics of the training data source and/or the particular training example. For example, the example sourcing information may identify the training data source, and if the training data source obtained the training example from a different source, the example sourcing information can identify that source as well. For another example, the example sourcing information can include a timestamp associated with collection of the training example, an analysis of the training example, results from a search of the training example, etc.

Additionally, or alternatively, in some implementations, the training verification information can include model training information. The model training information can describe characteristics of the machine-learned model while training the machine-learned model based on the particular training example. Examples of such characteristics can include a number of prior training iterations, versioning information for the model, metadata for the model that associates the model with a particular user, a supplementary input (e.g., a prompt) processed alongside the training example, parameter adjustments associated with the training example, etc.

The computing system can modify an auditable training ledger associated with the model. In particular, the computing system can append an entry for the particular training example to a plurality of existing entries of the auditable training ledger. The entry for the particular training example can be based on the training verification information.

In some implementations, once the auditable training ledger is sufficiently populated with entries, the computing system can leverage the auditable training ledger to identify or predict known training examples utilized to train some other machine-learned model. More specifically, the computing system can perform a training identification process for the LFM using the auditable training ledger. For example, assume that the computing system obtains an LFM trained by a third party. The computing system can process a plurality of testing inputs with the LFM to obtain a plurality of testing outputs. The testing inputs can be training examples with corresponding entries in the auditable training ledger.

Based on features included in the plurality of testing outputs, the computing system can generate a training profile for the LFM. The computing system can make a determination that some of the features included in the training profile are also included in the particular training example for which the entry in the auditable training ledger was generated. The computing system can then utilize the auditable training ledger to identify associations between the particular training example and known training datasets, thus identifying a “source” of the particular training example. In such fashion, implementations described herein enable accurate and efficient auditable data provenance for training dataset prediction in large foundational models.

Aspects of the present disclosure provide a number of technical effects and benefits. As one example, implementations described herein reduce, or eliminate, the substantial computational costs associated with mitigating security vulnerabilities stemming from malicious training examples. For example, assume it is discovered that a training example in a public dataset was modified maliciously at a particular time for the purposes of introducing vulnerabilities to models trained using that example. Using conventional approaches, entities that used the public dataset for training would be unsure whether that particular training example was used to train a model at all, much less whether such training occurred after the training example was maliciously modified. If unable to accurately audit the training example, entities that used the public dataset for training would be forced to repeat the entire training process, which requires the expenditure of enormous quantities of computing resources.

However, implementations described herein enable accurate and efficient auditable data provenance to determine whether the model was trained using the maliciously modified training example. Specifically, the auditable training ledger can be utilized to determine whether the maliciously modified example was used to train the model. Based on the determination, the model can be “rolled back” to a point in time prior to the example being used. Alternatively, modifications made to the model based on the training example can be “excised” or removed. In such fashion, implementations described herein can substantially reduce, or eliminate, the computational cost associated with re-training a model upon discovery of a maliciously modified training example.

As another example, implementations described herein can further mitigate malicious attacks that utilize a machine-learned model trained using training examples described by the auditable training ledger. For example, assume that a malicious actor utilizes a particular generative machine-learned model to perform malicious actions (e.g., generative model outputs used to perform phishing attacks, etc.). If an output of the generative model is used to perform a malicious action, and the output can be retrieved, a training identification process can be performed with the auditable training ledger to identify training datasets utilized to train the model. Once identified, the training datasets can be utilized to identify the particular generative model, and/or the actor using the generative model, so that future attacks can be more effectively mitigated.

As yet another example, implementations described herein can substantially improve the efficiency of the model training process, thus reducing the quantity of computing resources utilized during the process. For example, as described previously, entries can be added to the auditable training ledger for each training example utilized to train a model. Information obtained during the training process (e.g., modifications to parameters of the model, calculated losses, performance improvements following particular training epochs, etc.) can be stored within entries for the training examples. The auditable training ledger can then be analyzed to identify training examples with a “low” impact on the model (e.g., training examples that did not substantially affect the model). During subsequent training iterations, or when training a different model with the same dataset, training examples with less impact can be filtered from the training process, thus substantially reducing the computational resources required to train the model while retaining model performance.

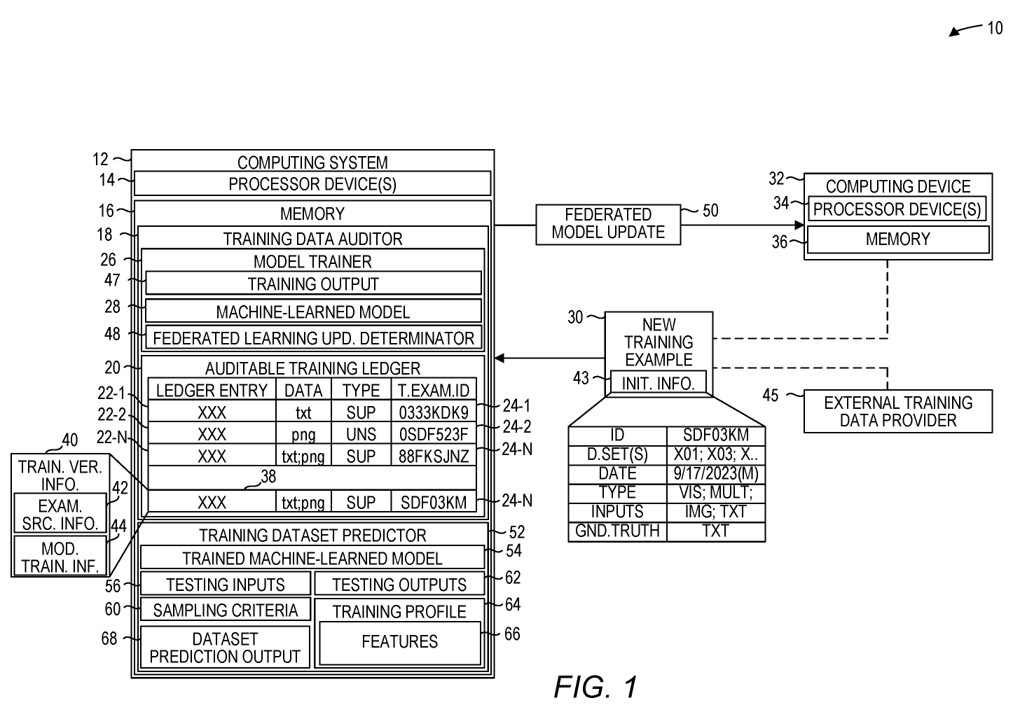

FIG. 1 is a block diagram of a computing environment 10 suitable for auditable data provenance for training dataset prediction in large foundational models according to some implementations of the present disclosure. The computing environment 10 can include a computing system 12 with one or more processor device(s) 14 and a memory 16. In some implementations, the computing system 12 may be a computing system that includes multiple computing devices. Alternatively, in some implementations, the computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the computing environment 10 can include multiple types of nodes. As described herein, a “node” generally refers to a discrete unit of hardware and/or software resources. In some instances, nodes within the computing environment can be configured to perform specific tasks. For example, some nodes within the computing environment can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

The memory 16 of the computing system 12 can include a training data auditor 18. The training data auditor 18 can include an auditable training ledger 20. The auditable training ledger 20 can be a database, data object, set of data elements, etc. that store information related to training examples used to train machine-learned models. In some implementations, the training data auditor 18 can mediate access to the auditable training ledger 20 based on access controls, permissions, dynamic access controls, etc. Access mediation for the auditable training ledger 20 will be discussed in greater detail further in the specification.

Generally, machine-learned models are trained using training examples. As described herein, a “training example” generally refers to input(s) that are processed with the purpose of optimizing a machine-learned model. Training examples may (or may not) include ground-truth information (e.g., labels, outputs, etc.) indicating a “correct” output that the model can be trained to reproduce when given the corresponding input of the training example.

The training data auditor 18 can perform operations necessary to populate an auditable training ledger 20, such as obtaining training examples, analyzing training examples, sourcing training examples, etc. The auditable training ledger 20 can include existing ledger entries 22A – 22N (generally, ledger entries 22) for a respective set of existing training examples 24A – 24N (generally, training examples 24).

The training data auditor 18 can include a model trainer 26. The model trainer 26 can utilize the training examples 24 to train a machine-learned model 28. More specifically, the model trainer 26 can perform a model training process to train the machine-learned model 28 by processing the training examples 24 with the machine-learned model 28 and adjusting parameters of the machine-learned model 28 based on outputs produced by the model while processing the training examples 24.

The model trainer 26 that trains the machine-learned model 28 can utilize various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some implementations, performing backwards propagation of errors can include performing truncated backpropagation through time. The model trainer 26 can perform a number of generalization techniques (e.g., weight decays, dropouts, etc.) to improve the generalization capability of the models being trained.

The machine-learned model 28 can be any type or manner of machine-learned model. The machine-learned model 28 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

The training examples 24 can include any type or manner of data, such as textual content, images, structured data (e.g., a data object such as a Javascript Object Notation (JSON) object), video, audio, programmatic software instructions, etc.). In some implementations, the training examples 24 can include a supervised training example. A supervised training example can include input(s) for a model and a corresponding ground-truth output for the model. For example, if the supervised training example is a training example for training an object recognition model, the supervised training example can include an image depicting an object and a ground-truth label that accurately labels the object. Additionally, or alternatively, in some implementations, the training examples 24 can include an unsupervised training example. An unsupervised training example can include input(s) for a model without a corresponding ground-truth output for the model.

The ledger entries 22 can include information associated with the corresponding training examples 24, and/or information associated with training the machine-learned model 28 with the training examples 24. Specifically, the ledger entries 22 can include training verification information. The training verification information can describe the training example and/or the training process that uses the training example. In some implementations, the training verification information can include example sourcing information. Example sourcing information can describe characteristics of the source of a training example, and/or the training example itself. Additionally, or alternatively, in some implementations, the training verification information can include model training information. Model training information can describe characteristics of a machine-learned model while training the model based on the training example.

To follow the depicted example, the computing system 12 can obtain a new training example 30. As described herein, the “new training example 30” may also be referred to interchangeably as a “particular training example 30.” In other words, the “new training example 30” may not necessarily be “new” to the computing system 12 and/or the training data auditor 18. Rather, the new training example 30 may be an existing training example that has been obtained previously.

In some implementations, the computing system 12 can obtain the new training example 30 from a computing device 32. The computing device 32 can be any type or manner of device (e.g., a smartphone, laptop, wearable device, Augmented Reality (AR) / Virtual Reality (VR) device, Internet-of-Things (IoT) device, etc.) and can include a processor device 34 and a memory 36 as described with regards to the processor device(s) 14 and the memory 16 of the computing system 12, respectively.

Upon receiving the new training example 30, the training data auditor 18 can generate a new ledger entry 38 in the auditable training ledger 20 for the new training example 30. The new ledger entry 38 can be generated based on as set of information elements. The set of information elements can include the new training example 30, training verification information, a training output, etc. In some implementations, the new ledger entry 38 can include hash representations of the set of information elements.

The new ledger entry 38 can include training verification information 40 for the new training example 30. In some implementations, the training verification information 40 can include example sourcing information 42. The example sourcing information 42 can describe characteristics of the training data source (e.g., the computing device 32, etc.) and/or the new training example 30. For example, the example sourcing information 42 may identify the training data source, and if the training data source obtained the new training example from another source, the example sourcing information 42 can identify that source as a “secondary” source. For another example, the example sourcing information 42 can include a timestamp associated with collection of the training example, an analysis of the training example, results from a search of the training example, etc.

Additionally, or alternatively, in some implementations, the training verification information 40 can include model training information 44. The model training information 40 can describe characteristics of the machine-learned model 28 while training the machine-learned model 28 based on the new training example 30. Examples of such characteristics can include a number of prior training iterations, versioning information for the model, metadata for the model that associates the model with a particular user, a supplementary input (e.g., a prompt) processed alongside the training example, information indicating a number of previous training iterations, parameter adjustments associated with the training example, information indicative of one or more supplementary inputs processed alongside the new training example 30 while training the machine-learned model 28 based on the new training example 30, etc.).

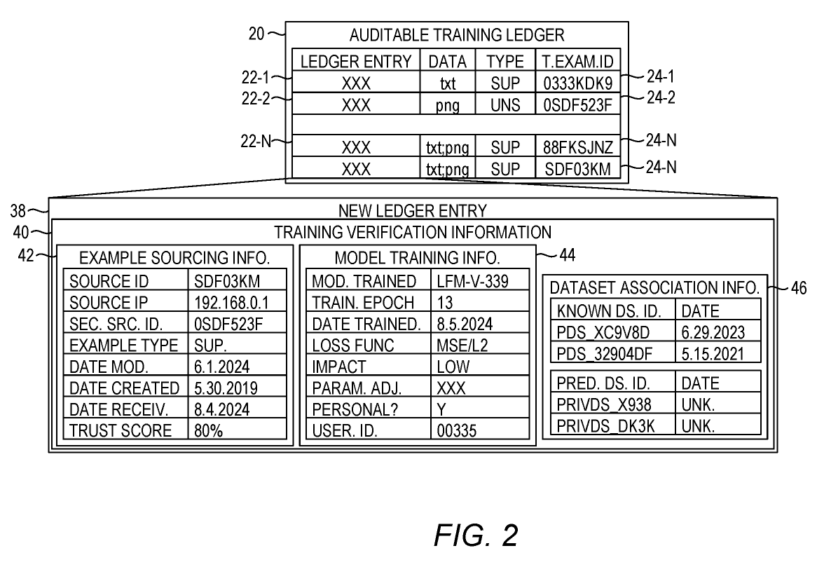

For a more specific example, turning to FIG. 2, FIG. 2 illustrates an example of the auditable training ledger of FIG. 1 including the new ledger entry that includes the training verification information according to some implementations of the present disclosure. FIG. 2 will be discussed in conjunction with FIG. 1. Specifically, the auditable training ledger 20 can include the new ledger entry 38, which can include the training verification information 40. The training verification information 40 can be obtained (e.g., received, generated, etc.) prior to, during, and/or after the new training example 30 is utilized to train the machine-learned model 28. In some implementations, the training verification information 40 can include the example sourcing information 42. The example sourcing information 42 can describe any characteristics of the new training example 30, and/or the training data source from which the new training example 30 was obtained.

To follow the depicted example, the example sourcing information 42 can include a source identifier (e.g., an internally-recognized identifier). The source identifier can identify a particular entity (e.g., an organization, a person, a business, a government entity, a computing system, a machine-learned model, etc.). For example, the training data auditor 18 can store information that associates the source identifier “SDF03KM” to a particular training data source (e.g., a business that creates synthetic training examples, etc.).

In some implementations, the example sourcing information 42 can include a source Internet Protocol (IP) address. The source IP can be a source IP address for a computing device that transmitted the new training example 30 to the computing system. For example, if the new training example 30 is received from the computing device 32, the source IP can be the IP address for the computing device 32.

In some implementations, the example sourcing information 42 can include a secondary source identifier. The secondary source identifier can identify a secondary source for the new training example 30. As described herein, a “secondary source” can generally refer to an entity that created the new training example 30 if the new training example 30 was not created by the entity identified by the source identifier. For example, assume that the source identifier of the example sourcing information 42 identifies a training data repository that stores and manages training datasets. Further assume that the training data repository acquired the new training example 30 from a separate entity that specializes in creating synthetic training examples. The example sourcing information 42 can include a secondary source identifier that identifies the entity that creates synthetic training examples.

In some implementations, the example sourcing information 42 can describe an example type characteristic for the new training example 40. The example type characteristic can indicate whether the new training example 40 is a supervised or unsupervised training example. In some implementations, the example sourcing information 42 can include temporal information indicating various dates associated with the new training example 30, such as a date the new training example 30 was created, a date the new training example 30 was last modified, a date the new training example 30 was received by the computing system 12, etc.

In some implementations, the example sourcing information 42 can include a trust score. The trust score can be, or otherwise include, a preliminary indication of trustworthiness for the new training example 30. In other words, the trust score can a likelihood that the new training example 30 is a malicious training example intended to exploit the machine-learned model 28. In some implementations, the trust score can be generated based on a machine-learned analysis of the training verification information 40. As such, in some implementations, the trust score can be appended to the example sourcing information 42.

In some implementations, the characteristics of the new training example 30 described by the example sourcing information 42, and/or the example sourcing information 42 itself, can be at least partially generated by the training data auditor 18. For example, to determine the secondary source characteristic, the training data auditor 18 can query a machine-learned model (e.g., an LLM), a search engine, a database, etc. to identify the secondary source. For another example, the training data auditor 18 can determine the source IP or source ID by querying the training data source (e.g., the computing device 32, etc.).

Additionally, or alternatively, in some implementations, the training data auditor 18 can obtain at least some of the example sourcing information 42 from other entities. For a specific example, returning to FIG. 1, if the new training example 30 is received from the computing device 32, the new training example 30 can be transmitted alongside initialization information 43. Some, or all, of the training verification information 40 can be included in or otherwise derived from the initialization information 43. For example, the initialization information 43 may include a source identifier and source IP for the computing device 32. For another example, if the computing device 32 obtained the new training example 30 from another entity, such as an external training data provider 45, the initialization information 43 can indicate the identity of the external training data provider 45.

Returning to FIG. 2, additionally, or alternatively, in some implementations, the training verification information 40 can include model training information 44. The model training information 44 can describe characteristics of the machine-learned model 28 while training the machine-learned model 28 based on the new training example 30. The model training information 44 can be obtained during and/or after the new training example 30 is utilized to train the machine-learned model 28.

To follow the depicted example, in some implementations, the model training information 44 can include a model identifier that identifies the machine-learned model being trained (e.g., the machine-learned model 28). In some implementations, the model training information 44 can indicate a particular training epoch in which the new training example 30 was used to train the machine-learned model 28. In some implementations, the model training information 44 can indicate a date and/or time at which the training epoch occurred.

In some implementations, the model training information 44 can indicate a particular loss function used to evaluate the new training example 30 to train the machine-learned model 28. For a specific example, returning to FIG. 1, assume that the new training example 30 is a supervised training example with an input and a ground-truth output. The model trainer 26 can train the machine-learned model 28 by processing the input from the new training example 30 with the machine-learned model 28 to obtain a training output 47. The model trainer 26 can utilize a mean-squared-error (MSE) / L2 loss function to evaluate a difference between the training output 47 and the ground-truth output. The model training information 44 can indicate that a MSE / L2 loss function was utilized to train the machine-learned model 28 based on the new training example 30.

Returning to FIG. 2, in some implementations, the model training information 44 can describe an “impact” characteristic. The impact characteristic can indicate a degree of “impact” caused by training the machine-learned model 28 based on the new training example 30. For example, if the new training example 30 is a supervised training example with a ground-truth output, and the training output 47 closely matches the ground-truth output, it is relatively unlikely that the weights or parameters of the machine-learned model 28 would be adjusted substantially based on the new training example 30. As such, the impact characteristic can indicate that training the machine-learned model 28 based on the new training example 30 had a relatively low impact. Conversely, if the training output 47 is substantially different than the ground-truth output, the impact characteristic can indicate that training the machine-learned model 28 based on the new training example 30 had a relatively high impact.

In some implementations, the model training information 44 can include a parameter adjustment characteristic that includes, describes, or otherwise indicates the adjustments to the parameters of the machine-learned model 28 that resulted from training the model based on the new training example 30. If the new training example 30 is subsequently identified as a malicious example, the parameter adjustment characteristic can be utilized to “roll back” or otherwise mitigate those changes to reduce the impact of the malicious example upon the machine-learned model 28.

In some implementations, the model training information 44 can indicate whether the machine-learned model 28 is a personalized model, and/or whether the new training example is a personalized training example. As described herein, a “personalized” model or model instance can refer to a model that has been tuned (e.g., trained, optimized, etc.) based on a particular entity, such as a user. For example, a model trained to select media content for a user can be personalized for a user based on training examples that feature the user (e.g., prior content items selected by the user, etc.). If the user prefers comedy movies, for instance, personalizing a model via personalized training examples can train the model to favor comedy movie suggestions over other genres.

In some implementations, the training verification information 40 can include dataset association information 46. The dataset association information 46 can be indicative of one or more associations between the new training example 30 and at least one known training dataset of a plurality of known training datasets. In some implementations, the dataset association information 46 can at least partially be included in or otherwise derived from the initialization information 43. Additionally, or alternatively, in some implementations, the dataset association information 46 can be generated by the training data auditor 18. For example, the training data auditor 18 can identify known public datasets by querying a model instance (e.g., an LLM), searching a search engine, database, etc.

Returning to FIG. 1, in some implementations, the training data auditor 18 can include a federated learning update determinator 48. The federated learning update determinator 48 can determine federated model updates by performing a “federated training process.” As described herein, a federated training process refers to a process in which training examples are collected from a variety of different devices that each include a local instance of a model. These training examples are then utilized to calculate a federated model update, which is provided to the computing devices so that their local models can be updated. A federated model update, which is also referred to as an “aggregated parameter update” herein, can be determined by aggregating model updates from multiple training data sources. In this manner, the computing system 12, and/or one (or more) of the training data sources, can serve as a training system for models.

For example, assume that the new training example 30 from the computing device 32 is one of a variety of new training examples received from different computing devices. The model trainer 26 can train the machine-learned model 28 based on the new training examples to determine a federated model update 50. The model trainer 26 can update the machine-learned model 28 with the federated model update 50. Additionally, or alternatively, in some implementations, the model trainer 26 can provide the federated model update 50 to the computing device 32 and other computing devices from which the new training examples were obtained. Additionally, in some implementations, the training data auditor 18 can store information to the auditable training ledger indicating that the new training example 30 was utilized in part in determining the federated model update 50. In other words, the auditable training ledger 20 can associate the new training example 30 and the other new training examples to the federated model update 50. Additionally, in some implementations, the new ledger entry 38 can include the federated model update 50 and/or information associated with the federated model update 50 (e.g., temporal information associated with the update, a version number associated with the update, information describing the update (e.g., parameter adjustments), etc.).

In some implementations, the memory 16 of the computing system 12 can include a training dataset predictor 52. The training dataset predictor 52 can utilize the auditable training ledger 20 to predict whether certain training examples were utilized in training a particular model. By predicting the utilization of certain training examples, the training dataset predictor 52 can further predict whether certain datasets that include those training examples were used to train the model.

To follow the depicted example, the training dataset predictor 52 can obtain a trained machine-learned model 54. The trained machine-learned model 54 can be any type or manner of model trained using conventional techniques. The training dataset predictor 52 can sample a set of testing inputs 56 from the training examples 24 (e.g., including the new training example 30). For example, assume that each of the training examples 24 includes a single input and a corresponding ground-truth output. The training dataset predictor 52 can sample the set of testing inputs 56 from the inputs included in the training examples 24 based on a sampling criteria 60.

In some implementations, the sampling criteria 60 can be, or otherwise be derived from, one or more of the characteristics described by the training verification information 40 within each of the ledger entries 22 for the corresponding training examples 24. For example, the sampling criteria may sample inputs from training examples with corresponding trust score characteristics (e.g. those above a threshold value), impact characteristic (e.g., those with a medium impact or higher), a creation date, a secondary source identifier, etc.).

The training dataset predictor 52 can process each testing input of the set of testing inputs 56 with the trained machine-learned model 54 to generate a corresponding testing output of a corresponding set of testing outputs 62. Based on the set of testing outputs 62, the training dataset predictor 52 can predict that one or more of the training examples 24 were used to train the trained machine-learned model 54. Additionally, or alternatively, in some implementations, the training dataset predictor 52 can identify one or more known training datasets predicted to have been used to train the trained machine-learned model.

To follow the depicted example, the training dataset predictor 52 can generate a training profile 64 for the trained machine-learned model 54. The training profile 64 can include, or can otherwise be based on, a number of features 66 included in the plurality of testing outputs. For example, assume that the trained machine-learned model 54 is a generative LLM that processes the testing inputs 56 to generate the testing outputs 62, which can include textual content. The features 66 can be certain words or phrases included in the set of testing outputs 62 that are likely to be identifying. For example, a common technical word or phrase such as “storage device” or “computer” are likely included in most training datasets for LLMs. However, rarer and more specific words or phrases, such as names, dates, fictional words, etc. are less likely to be included in certain datasets, and as such, can be selected for inclusion in the features 66.

Additionally, or alternatively, in some implementations, the features 66 can be or otherwise include intermediate representations of the set of testing outputs 62. For example, the features 66 can include one or more embeddings of words or phrases from the testing outputs 62. For another example, if the set of testing outputs 62 includes image outputs, the features 66 can include embeddings derived from the set of testing outputs 62. Additionally, or alternatively, the features 66 can include a semantic description of the set of testing outputs 62.

In some implementations, the training dataset predictor 52 can make a determination that one or more of the features 66 are included in a particular training example from the training examples 24. For example, assume that the features 66 include a fictional word only found in an obscure fictional book. Further assume that the new training example 30 is included in a particular dataset that is the only known dataset to include content from the author who wrote that fictional book (e.g., a dataset comprised of books written by lesser known authors, etc.). The training dataset predictor 52 can compare the features 66 to the ledger entries 22 for the training examples 24. Based on a comparison between the features 66 and the new ledger entry 38, the training dataset predictor 52 can determine that at least one of the features 66 is also included in the new training example 30.

In turn, based on the determination, the training dataset predictor 52 can generate a dataset prediction output 68. The dataset prediction output 68 can indicate a particular dataset predicted to uniquely include the content from the author who wrote the fictional book was likely used to train the trained machine-learned model 54. In such fashion, implementations described herein can leverage the auditable training ledger 20 to identify datasets that were used to train particular models. In turn, by identifying the datasets used to train a model, implementations described herein can determine whether a model is safe to use or may include vulnerabilities due to malicious training examples included in such datasets.

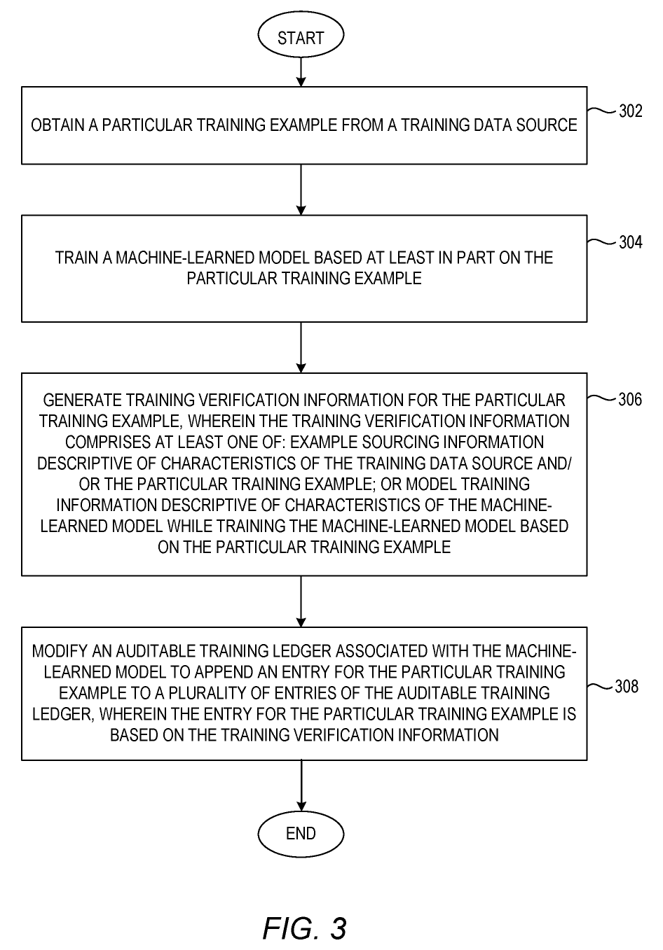

FIG. 3 is a flowchart illustrating operations performed by the computing system of FIG. 1 for auditable data provenance for training dataset prediction in large foundational models, according to one example. Elements of FIG. 1 are referenced in describing FIG. 3 for the sake of clarity. In FIG. 3, operations begin with a processor device of a computing device, computing system, network node, etc., such as the processor device(s) 14 of the computing system 12 of FIG. 1. The processor device(s) 14 are to obtain a particular (i.e., new) training example 30 from a training data source (block 302). The processor device(s) 14 are further to train a machine-learned model 28 based at least in part on the particular training example 30 (block 304). The processor device(s) 14 are further to generate training verification information 40 for the particular training example 30, wherein the training verification information 40 comprises at least one of example sourcing information 42 descriptive of characteristics of the training data source (e.g., the computing device 32, etc.) and/or the particular training example 30, or model training information 44 descriptive of characteristics of the machine-learned model 28 while training the machine-learned model 28 based on the particular training example 30 (block 306). The processor device(s) 14 are further to modify an auditable training ledger 20 associated with the machine-learned model 28 to append an entry 38 for the particular training example 30 to a plurality of entries 24 of the auditable training ledger 20, wherein the entry 38 for the particular training example 30 is based on the training verification information 40 (block 308).

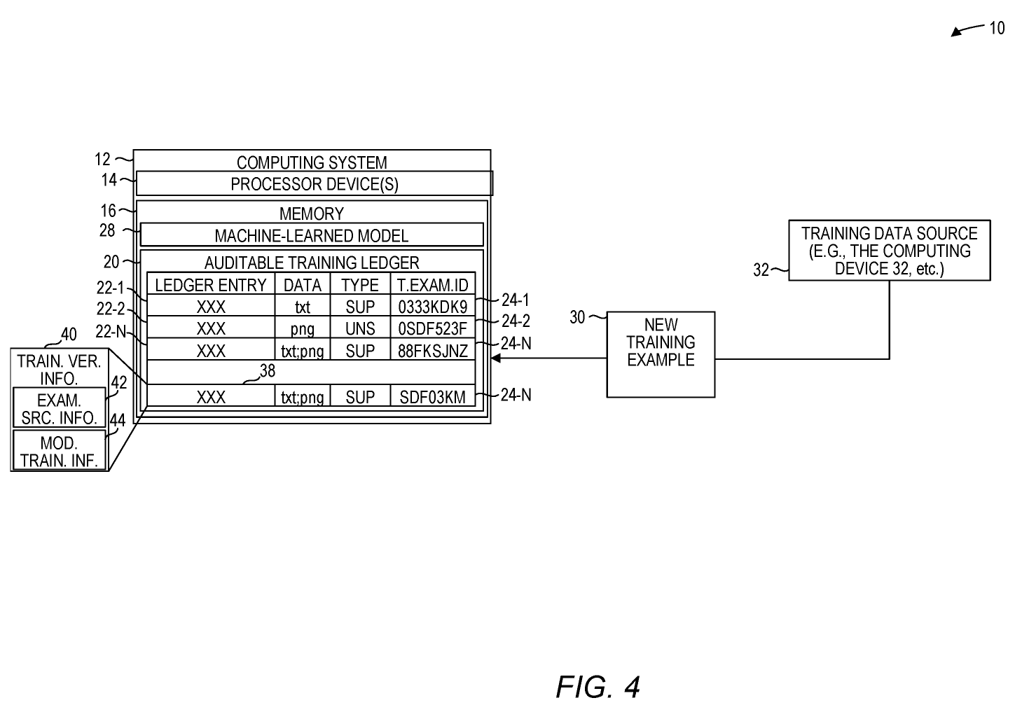

FIG. 4 is a block diagram of the computing device of FIG. 1 for auditable data provenance for training dataset prediction in large foundational models, according to one example. Elements of FIG. 1 are referenced in describing FIG. 4 for the sake of clarity. In the example of FIG. 4, the computing system 12 includes a memory 16 and processor device(s) 14 coupled to the memory 16. The processor device(s) 14 are to obtain a training example 30 from a training data source (e.g., the computing device 32, etc.). The processor device(s) 14 are further to train a machine-learned model 28 based at least in part on the particular training example 30. The processor device(s) 14 are further to generate training verification information 40 for the particular training example 30, wherein the training verification information 40 comprises at least one of example sourcing information 42 descriptive of characteristics of the training data source (e.g., the computing device 32, etc.) and/or the particular training example 30, or model training information 44 descriptive of characteristics of the machine-learned model 28 while training the machine-learned model 28 based on the particular training example 30. The processor device(s) 14 are further to modify an auditable training ledger 20 associated with the machine-learned model 28 to append an entry 38 for the particular training example 30 to a plurality of entries 24 of the auditable training ledger 20, wherein the entry 38 for the particular training example 30 is based on the training verification information 40.

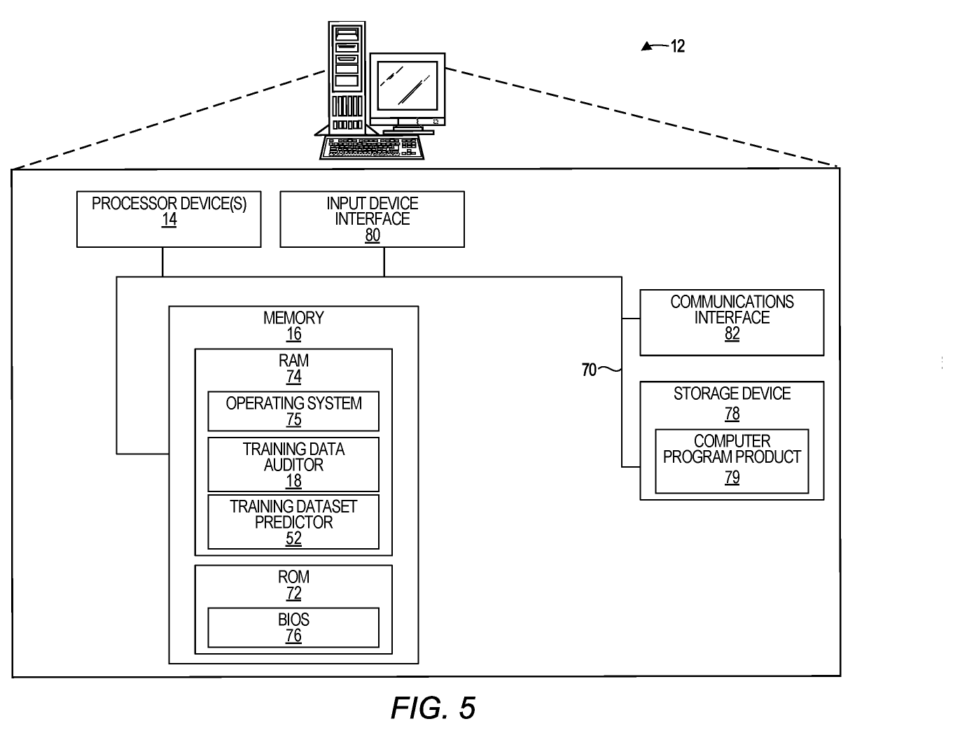

FIG. 5 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 70. The system bus 70 provides an interface for system components including, but not limited to, the memory 16 and the processor device(s) 14. The processor device(s) 14 can be any commercially available or proprietary processor.

The system bus 70 may be any of several types of bus structures that may further interconnect to a memory bus (with or without a memory controller), a peripheral bus, and/or a local bus using any of a variety of commercially available bus architectures. The memory 16 may include non-volatile memory 72 (e.g., read-only memory (ROM), erasable programmable read-only memory (EPROM), electrically erasable programmable read-only memory (EEPROM), etc.), and volatile memory 74 (e.g., random-access memory (RAM)). A basic input/output system (BIOS) 76 may be stored in the non-volatile memory 72 and can include the basic routines that help to transfer information between elements within the computing system 12. The volatile memory 74 may also include a high-speed RAM, such as static RAM, for caching data.

The computing system 12 may further include or be coupled to a non-transitory computer-readable storage medium such as the storage device 78, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 78 and other drives associated with computer-readable media and computer-usable media may provide non-volatile storage of data, data structures, computer-executable instructions, and the like.

A number of modules can be stored in the storage device 78 and in the volatile memory 74, including an operating system 75 and one or more program modules, such as the training data auditor 18 and the training dataset predictor 52, which may implement the functionality described herein in whole or in part. All or a portion of the examples may be implemented as a computer program product 79 stored on a transitory or non-transitory computer-usable or computer-readable storage medium, such as the storage device 78, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the training data auditor 18 and the training dataset predictor 52 in the volatile memory 74, may serve as a controller, or control system, for the computing system 12 that is to implement the functionality described herein.

Because the training data auditor 18 and the training dataset predictor 52 are components of the computing system 12, functionality implemented by the training data auditor 18 and the training dataset predictor 52 may be attributed to the computing system 12 generally. Moreover, in examples where the training data auditor 18 and the training dataset predictor 52 comprise software instructions that program the processor device(s) 14 to carry out functionality discussed herein, functionality implemented by the training data auditor 18 and the training dataset predictor 52 may be attributed herein to the processor device(s) 14.

It is further noted that while the training data auditor 18 and the training dataset predictor 52 are shown as separate components, in other implementations, the training data auditor 18 and the training dataset predictor 52 could be implemented in a single component or could be implemented in a greater number of components than two.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 80 that is coupled to the system bus 70 but can be connected by other interfaces such as a parallel port, an Institute of Electrical and Electronic Engineers (IEEE) 1394 serial port, a Universal Serial Bus (USB) port, an IR interface, and the like. The computing system 12 may also include a communications interface 82 suitable for communicating with a network as appropriate or desired. The computing system 12 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a computing system comprising one or more computing devices, a particular training example from a training data source;
training, by the computing system, a machine-learned model based at least in part on the particular training example;
generating, by the computing system, training verification information for the particular training example, wherein the training verification information comprises at least one of:
example sourcing information descriptive of characteristics of the training data source and/or the particular training example; or
model training information descriptive of characteristics of the machine-learned model while training the machine-learned model based on the particular training example; and
modifying, by the computing system, an auditable training ledger associated with the machine-learned model to append an entry for the particular training example to a plurality of entries of the auditable training ledger, wherein the entry for the particular training example is based on the training verification information.

2. The method of claim 1, wherein training the machine-learned model based at least in part on the particular training example comprises:
processing, by the computing system, the particular training example with the machine-learned model to obtain a training output; and
adjusting, by the computing system, one or more parameters of the machine-learned model based on a loss function that evaluates the training output and the particular training example.

3. The method of claim 2, wherein modifying the auditable training ledger associated with the machine-learned model to append the entry for the particular training example to the plurality of entries of the auditable training ledger comprises:
generating, by the computing system, the entry for the particular training example based on a set of information elements, wherein the set of information elements comprises at least one of:
the particular training example;
the training verification information; or
the training output.

4. The method of claim 3, wherein generating the entry for the particular training example based on the set of information elements comprises:
processing, by the computing system, the set of information elements to generate a corresponding set of hash representations.

5. The method of claim 3, wherein the set of information elements further comprises dataset association information indicative of one or more associations between the particular training example and at least one known training dataset of a plurality of known training datasets.

6. The method of claim 1, wherein each of the plurality of entries are generated for a corresponding training example of a plurality of training examples comprising the particular training example.

7. The method of claim 5, wherein the method further comprises:
performing, by the computing system with the auditable training ledger, a training identification process for a trained machine-learned model to generate a dataset prediction output, wherein the dataset prediction output identifies one or more known training datasets of the plurality of known training datasets predicted to have been used to train the trained machine-learned model.

8. The method of claim 7, wherein performing the training identification process for the trained machine-learned model to generate the dataset prediction output comprises:
processing, by the computing system, a plurality of testing inputs with the trained machine-learned model to obtain a respective plurality of testing outputs; and
based on the plurality of testing outputs, identifying the one or more known training datasets predicted to have been used to train the trained machine-learned model.

9. The method of claim 8, wherein identifying the one or more known training datasets predicted to have been used to train the trained machine-learned model comprises:
generating, by the computing system, a training profile for the trained machine-learned model based on a plurality of features included in the plurality of testing outputs;
making, by the computing system, a determination that one or more of the plurality of features are included in the particular training example based at least in part on the entry for the particular training example in the auditable training ledger; and
identifying, by the computing system, a first known training dataset of the one or more known training datasets predicted to have been used to train the trained machine-learned model based on a portion of the entry for the particular training example in the auditable training ledger, wherein the portion of the entry is based on the dataset association information, and wherein the portion of the entry is indicative of an association between the particular training example and the first known training dataset.

10. The method of claim 1, wherein the training verification information comprises the example sourcing information descriptive of the characteristics of the training data source and/or the particular training example, comprising at least one of:
an identity of the training data source;
an identity of a secondary training data source from which the particular training example was obtained by the training data source;
a timestamp associated with collection of the particular training example; or
metadata associated with the particular training example.

11. The method of claim 10, wherein the identity of the training data source comprises a user of a user device, and wherein the machine-learned model comprises a personalized model that is personalized for the user.

12. The method of claim 10, wherein the training data source comprises a training system, wherein the particular training example comprises an aggregated parameter update determined by the training system with a federated training process based on a plurality of training examples, and wherein training the machine-learned model based at least in part on the particular training example comprises:
applying, by the computing system, the aggregated parameter update to the machine-learned model.

13. The method of claim 1, wherein the training verification information comprises the model training information descriptive of the characteristics of the machine-learned model while training the machine-learned model based on the particular training example, comprising at least one of:
a number of previous training iterations;
versioning information for the machine-learned model;
information indicating that the machine-learned model is a personalized model associated with a particular user;
information indicative of one or more supplementary inputs processed alongside the particular training example while training the machine-learned model based on the particular training example; or
information indicative of adjustments made to one or more parameters of the machine-learned model while training the machine-learned model based on the particular training example.

14. A computing system comprising:
one or more processor devices to:
obtain a particular training example from a training data source;
train a machine-learned model based at least in part on the particular training example;
generate training verification information for the particular training example, wherein the training verification information comprises at least one of:
example sourcing information descriptive of characteristics of the training data source and/or the particular training example; or
model training information descriptive of characteristics of the machine-learned model while training the machine-learned model based on the particular training example; and
modify an auditable training ledger associated with the machine-learned model to append an entry for the particular training example to a plurality of entries of the auditable training ledger, wherein the entry for the particular training example is based on the training verification information.

15. The computing system of claim 14, wherein, to train the machine-learned model based at least in part on the particular training example, the one or more processor devices are to:
process the particular training example with the machine-learned model to obtain a training output; and
adjust one or more parameters of the machine-learned model based on a loss function that evaluates the training output and the particular training example.

16. The computing system of claim 15, wherein, to modify the auditable training ledger associated with the machine-learned model to append the entry for the particular training example to the plurality of entries of the auditable training ledger, the one or more processor devices are to:
generate the entry for the particular training example based on a set of information elements, wherein the set of information elements comprises at least one of:
the particular training example;
the training verification information; or
the training output.

17. The computing system of claim 16, wherein, to generate the entry for the particular training example based on the set of information elements, the one or more processor devices are to:
process the set of information elements to generate a corresponding set of hash representations.

18. The computing system of claim 16, wherein the set of information elements further comprises dataset association information indicative of one or more associations between the particular training example and at least one known training dataset of a plurality of known training datasets.

19. The computing system of claim 14, wherein each of the plurality of entries are generated for a corresponding training example of a plurality of training examples comprising the particular training example.

20. A non-transitory computer-readable storage medium that includes executable instructions to cause one or more processor devices to:
obtain a particular training example from a training data source;
train a machine-learned model based at least in part on the particular training example;
generate training verification information for the particular training example, wherein the training verification information comprises at least one of:
example sourcing information descriptive of characteristics of the training data source and/or the particular training example; or
model training information descriptive of characteristics of the machine-learned model while training the machine-learned model based on the particular training example; and
modify an auditable training ledger associated with the machine-learned model to append an entry for the particular training example to a plurality of entries of the auditable training ledger, wherein the entry for the particular training example is based on the training verification information.
